(19) United States
(12) Patent Application Publication
(10) Pub. No.: US 2010/0250217 A1
(43) Pub. Date: Sep. 30, 2010

(54) Docking Pose Selection Optimization via NMR Chemical Shift Perturbation Analysis

(75) Inventors: Bing Wang, Gainesville, FL (US); Kenneth Malcom Merz, JR., Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: UNIVERSITY OF FLORIDA RESEARCH FOUNDATION ,INC., Gainesville, FL (US)

(21) Appl. No.: 12/675,503

(22) PCT Filed: Aug. 28, 2008
(86) PCT No.: PCT/US2008/074571

§ 371 Date: Feb. 26, 2010

Related U.S. Application Data
(60) Provisional application No. 60/969,186, filed on Aug. 31, 2007.

(51) Int. Cl. G06G 7/48

(52) U.S. Cl. 703/11

(57) ABSTRACT

Using NMRScore to generate an RMSD and evaluating whether the RMSD is below 1 ppm, in order to indicate that a docking software generated pose is a good match with the experimental assessment of a paradigm protein target and paradigm ligand, and therefore that the pose will be useful and accurate for the same target and similar ligands, or similar targets and the same ligands.

### CROSS REFERENCE TO RELATED APPLICATION

This patent application claims priority to U.S. Provisional Application Ser. No. 60/969,186, filed Aug. 31, 2007, which is hereby incorporated herein by reference.

### STATEMENT REGARDING FEDERALLY SPONSORED RESEARCH

The subject matter of this patent application was developed at least in part within a grant from the National Institutes of Health Grant No. R42STTR GM079899. The United States government may have certain rights to the invention.

### BACKGROUND OF THE INVENTION

1. Field of the Invention

The present invention relates to optimization of docking pose selection, in the use of virtual screening tools in structure-based drug design, using NMR chemical shift perturbations (CSP).

2. Description of Related Art

The determination of the three-dimensional structures of protein-ligand complexes is the critical step in structure based drug design. Recent technological advances in X-ray crystallography and NMR spectroscopy have dramatically increased the number of high-resolution structures of proteins and protein-ligand complexes. Despite their success, none of these two techniques are high-throughput enough to keep the pace of the discovery of new lead molecules and therapeutic targets in the post-genomic era. Therefore, surrogate (non-experimental) approaches like molecular docking are used as virtual screening tools in the structure-based drug discovery workflow employed in the pharmaceutical and biotechnology industries. Interestingly, several NMR experimental approaches have been developed to determine the ligand binding mode without solving the 3D structure of protein-ligand complex by combining docking programs with NMR parameters such as saturation transfer difference (STD) and nuclear Overhauser effects (NOE).

Basically, molecular docking is used to generate poses that may or may not represent the best complementary match between two molecules—a receptor and a ligand. These poses are then scored using various scoring functions to predict which best represents the experimental or native conformation. The first step is a conformational sampling procedure, which can be performed using a genetic algorithm, Monte Carlo simulation, simulated annealing, distance geometry, and other miscellaneous methods. The final docked conformations are selected based on a scoring function. In principle, the binding affinity from a rigorous free energy simulation is an ideal scoring function. However, it is not practical to use such a time-consuming approach in docking studies. Therefore, most current scoring functions are derived from force fields, empirical or knowledge-based potentials. Several comparative studies of various scoring functions have been reported. Unfortunately, the consensus is that energy-based functions are not accurate enough at this time to discriminate the native ligand structure from decoy sets, which means that the virtual screening tools are, when assessed by energy-based functions, simply not reliable. A need therefore remains for optimization methods, for virtual docking poses, that allow selection of docking poses that will accurately portray the modeled biological systems and thus provide meaningful docking pose tools for new drug design.

### SUMMARY OF THE INVENTION

In order to meet this need, the present invention is a method for using NMR chemical shift data (CSD), via a “divide and conquer” method, to calculate binding-induced chemical shift perturbations (CSP) for an entire protein-ligand complex at the quantum mechanical level for the purpose of culling accurate docking poses from among those generated by commercial docking software. For example, an investigator contemplating a protein target and a possible new drug small molecule can take a number of scoring poses, from commercial docking software, and assess experimentally—empirically—either the small molecule or the protein, or both, by NMR chemical shift perturbations. Using NMRScore as described herein, when NMRScore gives an RMSD of below 1 ppm, the RMSD indicates that the pose is a good match with the experimental assessment of a paradigm protein target and paradigm ligand, and therefore that the pose will be useful and accurate for the same target and similar ligands, or similar targets and the same ligands.

### BRIEF DESCRIPTION OF THE DRAWING(S)

FIG. 1 is the chemical structure of GPI, showing the isopentyl moiety, the pyrrolidine moiety, and the pyridine moiety.

FIG. 2 is the binding site structure taken from NMR_{—}6 (1F40).

FIGS. 3A and 3B show AutoDock derived poses and scores.

FIG. 4 is the binding site structure taken from Autodock_{—}19, which shows that the pyridine moiety of GPI is predicted to dock into a shallow groove formed by Phe46, Phe48 and Glu54.

FIG. 5 show Dock derived poses and scores.

FIG. 6 is the binding site structure taken from Dock_{—}1.

FIG. 7 is the binding site structure of Dock_{—}3.

FIGS. 8A and 8B show EHITS Score vs. the structural RMSD; and NMRScore versus the structural RMSD using EHITS derived poses. The squares represent the experimental NMR ensemble structures of the GPI-FKBP complex.

FIGS. 9A and 9B show FlexX Score vs. the structural RMSD; and NMRScore versus the structural RMSD using FlexX poses. The squares represent the experimental NMR ensemble structures of the GPI-FKBP complex.

FIGS. 10A and 10B show Fred Score vs. the structural RMSD; and NMR-Score versus the structural RMSD using Fred poses. The squares represent the experimental NMR ensemble structures of the GPI-FKBP complex.

FIGS. 11A and 11B show Glide Score vs. the structural RMSD; and NMRScore versus the structural RMSD using Glide poses. The squares represent the experimental NMR ensemble structures of the GPI-FKBP complex.

FIGS. 12A and 12B show LibDock Score vs. the structural RMSD; and NMRScore versus the structural RMSD using LibDock poses. The squares represent the experimental NMR ensemble structures of the GPI-FKBP complex.

FIG. 13 is the binding site structure of LibDock_{—}28 (Green) and NMR_{—}6 (Cyan).

FIG. 14 is the binding site structure of MOE_{—}1.

FIGS. 15A and 15B show MOE Score vs. the structural RMSD; and NMRScore versus the structural RMSD using MOE poses. The squares represent the experimental NMR ensemble structures of the GPI-FKBP complex.

### DESCRIPTION OF THE PREFERRED EMBODIMENT(S)

The present invention is a method for using NMR chemical shift data (CSD), via a “divide and conquer” method, to calculate binding-induced chemical shift perturbations (CSP) for an entire protein-ligand complex at the quantum mechanical level for the purpose of culling accurate docking poses from among those generated by commercial docking software. For example, an investigator contemplating a protein target and a possible new drug small molecule can take a number of scoring poses, from commercial docking software, and assess in real life either the small molecule or the protein, or both, by NMR chemical shift perturbations. Using NMRScore as described herein, when NMRScore gives an RMSD of below 1 ppm, the RMSD indicates that the pose is a good match with the experimental assessment of a paradigm protein target and paradigm ligand, and therefore that the pose will be useful and accurate for the same target and similar ligands, or similar targets and the same ligands.

Ligands according to the present invention may be any molecule of interest including but not limited to a peptide, an oligopeptide, a protein, a DNA molecule, an RNA molecule, a PNA molecule, or a small molecule drug candidate for drug discovery. According to the invention, a “small molecule drug candidate for drug discovery” is a molecule having a molecular weight of ˜500 (“about 500”) or less that is of interest as a ligand for evaluation of binding to a paradigm protein target according to the invention.

In order to verify the invention described herein, we have generated docking poses for the FKBP-GPI complex using eight docking programs known in the art, including AutoDock, eHiTs, FlexX, Fred, Glide, LibDock, and MOE, and compared their scoring functions with scoring based on NMR chemical shirt perturbations (NMRScore). We calculated the binding-induced chemical shift perturbations (CSP) using our recently developed semi-empirical quantum mechanical method and compared them with available experimental values. Because the CSP is exquisitely sensitive regarding the orientation of ligand inside the binding pocket, NMRScore offers an accurate and straightforward approach to score different poses (“xyz” positioning determined with direct NMR CSP data). All scoring functions were inspected by their abilities highly to rank the native-like structures and separate them from decoy poses generated for a protein-ligand complex. The overall performance of NMRScore is much better than that of energy-based scoring functions associated with docking programs in both aspects. We have therefore concluded that the combination of docking programs with NMRScore results in an approach that robustly determines the binding site structure for a protein-ligand complex, and thus provides a new and important tool to facilitate structure-based drug discovery.

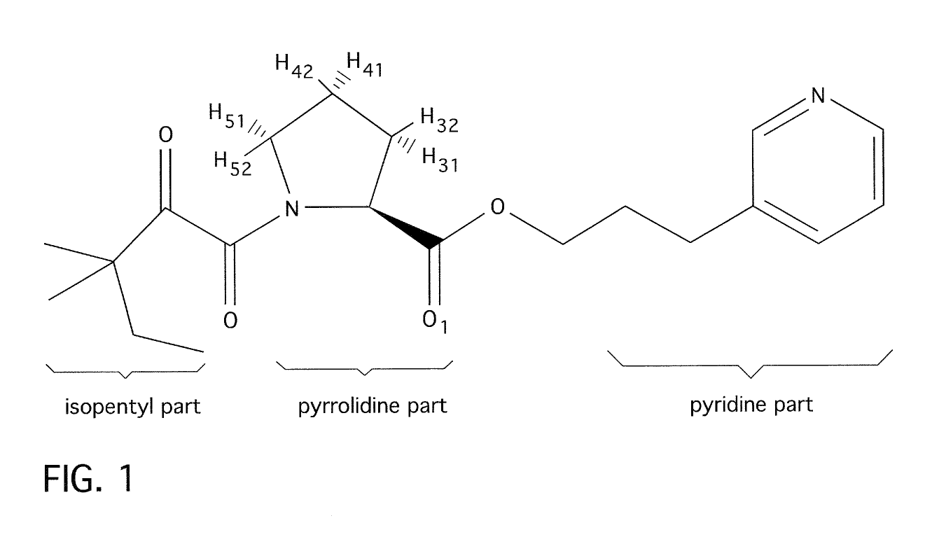

The foregoing describes in greater detail the use of NMRScore to accomplish the above result. We have developed an accurate and fast approach to calculate NMR chemical shifts for biological systems using the divide-and-conquer method. This represents the first time that anyone has been able to, or even attempted, to calculate binding-induced chemical shift perturbations for an entire protein-ligand complex at the quantum mechanical level. We have previously applied this approach to the study of the FKBP-GPI complex. The GPI molecule as shown in FIG. 1 is an effective inhibitor for the peptidyl-prolyl cis-trans isomerase (PPIase) activity of FKBP. Ten NMR structures of this complex have been determined by Sich et al. (PDB code: IF40). An excellent agreement between the experimental and calculated proton chemical shifts was obtained for the NMR models with Ile56-O1 (ligand) hydrogen bonds. Other models without this hydrogen bond tended to have much larger CSP root-mean-squared deviations (RMSD) between experiment and theory. This finding shows that this Ile56-O1 hydrogen bond is important for molecular recognition. Moreover, our approach was able to validate the binding site structure for the observed protein-ligand complex. Another application of our approach was to select the correct ligand structure set for a set of decoy poses. Because CSP can be readily measured by NMR experiment with high precision, the RMSD between experimental and calculated CSP offers a straightforward manner to score different poses for a given protein-ligand complex. We have now confirmed that NMRScore is able to improve the overall performance of scoring ligand poses in a protein binding pocket when compared to conventional scoring functions. To achieve this goal, we have docked the GPI molecule into the FKBP binding pocket using eight popular docking programs, namely, AutoDock, Dock, eHiTs, FlexX, Fred, Glide, LibDock, and MOE. Then we compared the performance of the scoring function associated with each docking program with that of NMRScore.

The following describes the docking procedures that we used. A computational workflow specific to each of the docking/scoring functions was performed leading to eight different populations of poses (one for each function). Before performing any scoring simulations, sets of ligand (GPI—See FIG. 1) and enzyme (FKBP) input files were produced for each of the 10 NMR models in the NMR ensemble within the FKBP/GPI PDG file (1F40). Each of these input files included the fully protonated structures and experimentally determined coordinates originally found within 1F40. Atomic charges were assigned to each ligand atom using the Antechamber/DivCon application from the AMBER suite of programs, and these charges were used for all score functions. Standard Cornell et al. ff94 atomic charges were assigned for FKBP. No pre-minimization or other cleanup was performed; hence, experimental coordinates were used throughout. Beginning with these standard input files, the eight docking/scoring studies summarized in Table 1 were performed (using both flexible ligand and rigid ligand docking) leading to eight different pose populations encompassing hundreds or thousands of different poses per function. In order to limit redundant poses within each population, the poses were clustered across the 10 NMR models using a 1.0 angstrom RMSD cutoff.

TABLE 1
Summary of Docking/Scoring Protocols.

| | Flexible | Total | Cluster | Final | |
|---|---|---|---|---|---|
| Program | Ligand | Poses | RMSD | Poses | Notes |
| Autodock | Yes | 2560 | 1.0 Å | 30 | In house, Used standard |
| | | | | | settings |
| Dock (1) | Yes | 300 | 1.0 Å | 30 | In house, Used 20 atom |
| | | | | | flexibility and rigid |
| | | | | | docking |
| eHiTS | Yes | 500 | 1.0 Å | 30 | In house, Used - advanced |
| | | | | | keyword |
| FlexX | Yes | 250 | 1.0 Å | 30 | In collaboration with |
| | | | | | BioSolveIT |
| Fred | Yes | 3000 | 1.0 Å | 30 | In collaboration with |
| | | | | | OpenEye |
| Glide | No | 285 | 1.0 Å | 30 | In collaboration with J&J |
| LibDock | Yes | 5000 | 1.0 Å | 30 | In collaboration with |
| | | | | | Pharmacopeia |
| MOE | Yes | 300 | 1.0 Å | 30 | In collaboration with CCG |

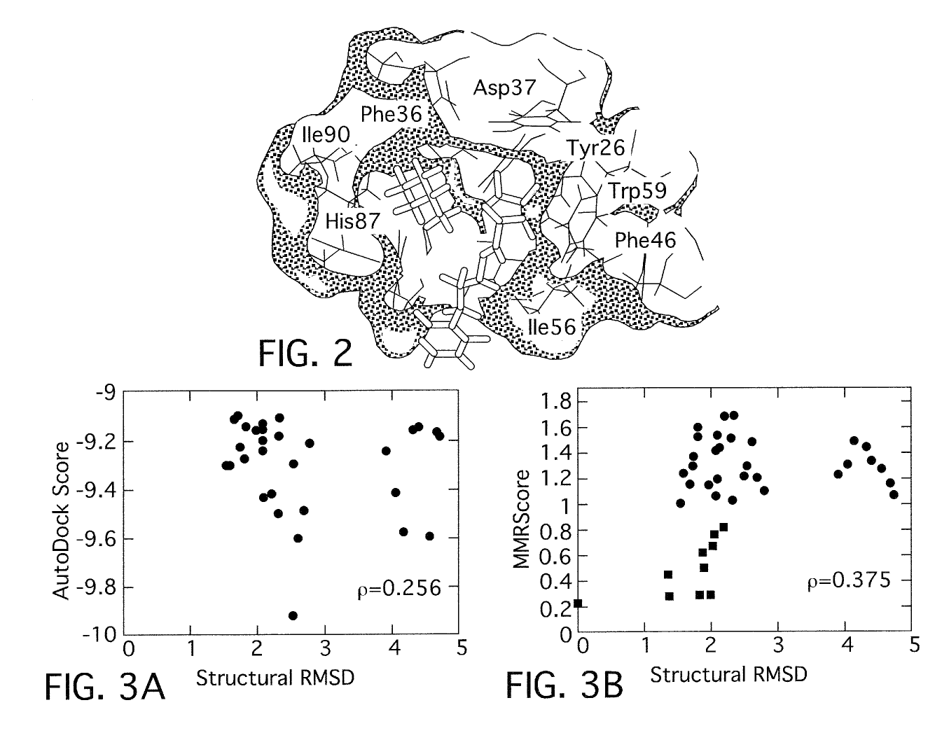

The following describes the scoring procedure. Once the RMSD clustering was complete (see above), the top 30 ranked poses for each program were used to calculate NMR chemical shift perturbations as implemented in a DivCon (“divide and conquer”) program. We used the following specification to identify each docking pose: docking program_ number. The number is the ranking according to the corresponding scoring function in the docking program. For example, AutoDock_{—}2 means the second ranked (i.e., the second best predicted pose) structure generated by AutoDock. We computed the CSP RMSD from the experimental values to generate the value for NMRScore. The lower the CSP RMSD, the better the NMRScore. To calculate the structure RMSD, we referenced every pose to NMR_{—}6 (the sixth structural model from the 10 structure NMR ensemble) because it had the lowest CSP RMSD and we think it is the best NMR model for the “true” native structure (see FIG. 2). For each docking program, we generated two figures summarizing the results: one is the program score versus structural RMSD, and the other one is the NMRScore versus structural RMSD. We also included the NMRScore for the remaining experimental NMR structures of the FKBP-GPI complex from the NMR ensemble for reference in the latter figure. In addition, we showed the Spearman correlation coefficient ρ (see equation 1, below) for each scoring function and NMRScorer against structural RMSD. A perfect scoring function needs only to provide the correct rankings of candidate molecules, no matter what values of this scoring function. The Spearman correlation coefficient is a non-parametric measure of correlation and a proper quantitative measurement for this purpose.

$$ρ = 1 - \frac{6 {\sum }_{i = 1}^{n} {d}_{1}^{2}}{n ( {n}^{2} - 1 )} \qquad EQUATION 1$$

Equation 1 shows the scoring calculation described herein wherein dᵢ is the ranking difference of the “ith” pose between the structural RMSD and the scoring function (or NMRScore). N is number of pairs of values. In theory, ρ falls between −1 and +1, where +1 corresponds to a perfect correlation, −1 corresponds to a perfect inverse correlation, and zero corresponds to no correlation.

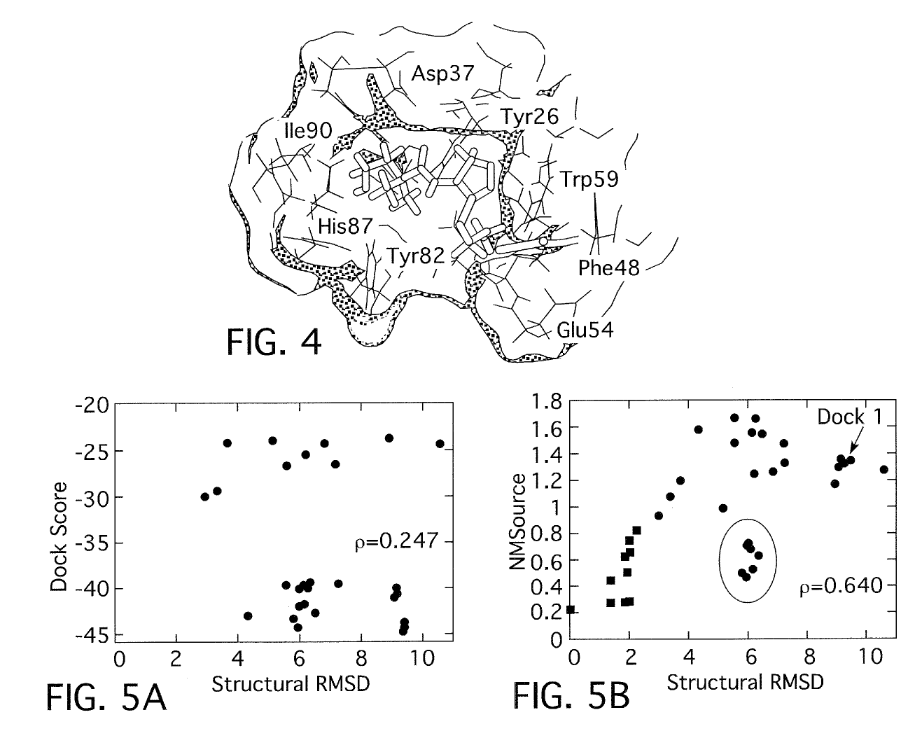

When the above docking and scoring were completed, the 30 poses generated by AutoDock were clustered into two groups: one with a structural RMSD from 1.5 angstroms to 2.6 angstroms and the other from 3.9 angstroms to 4.7 angstroms as shown in FIG. 3A. The pyridine moiety as shown in FIG. 1 from the second RMSD grouping docks into a shallow groove formed by Phe46, Phe48, and Glu 54, instead of the pocket formed by Ile56, Tyr82, and His87 as seen in the native structure (see FIG. 4). The other regions of GPI are bound in a manner similar to that seen in the native structure. The AutoDock scoring function is based on a force field, which is typically not specifically developed for describing protein-ligand interactions. Therefore, it is not surprising that the Spearman correlation coefficient is negative for the AutoDock score. NMRScore demonstrates that all of the “best” Autodock poses (see FIG. 3B) are not good models for the orientation of GPI in the FKBP binding pocket. When the NMRS core gives an RMSD of below 1 ppm, the RMSD indicates a good match with the experiment. None of the AutoDock structures reached this threshold and as a result we concluded, correctly, that the AutoDock pose had not placed the ligand in a native-like configuration.

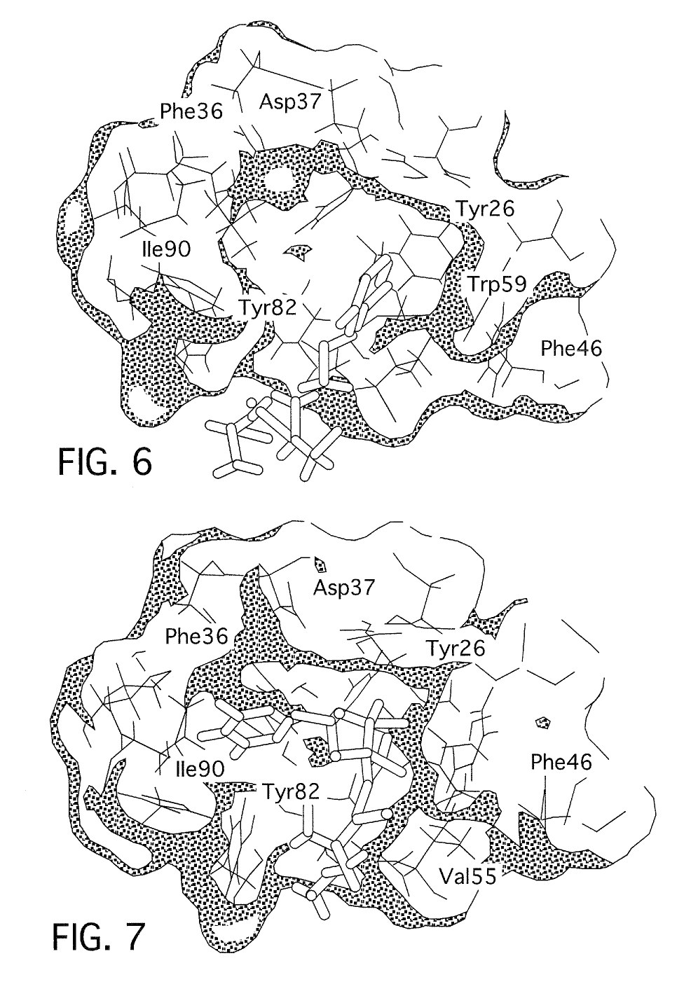

Two different settings of the Dock program were employed in order to utilize both flexible (20 atoms of GPI were flexible) and rigid ligand docking (for the results shown in FIG. 5). The range of structural RMSD for the docked poses was from 3 to 11 angstroms. Since there are several scoring functions available in the Dock program, we used the grid-based scoring function as a primary scoring function. According to this force field based scoring function, the rigid docking poses have less favorable (more positive) Dock scores than the flexible docking poses (see FIG. 5A). Dock_{—}1 and Dock_{—}2 placed the pyridine moiety into the major binding pocket (see FIG. 6), resulting in a large structural RMSD (around 9.3 angstroms) and an NMRScore of about 1.35 ppm.

Dock_{—}3 and Dock_{—}6 have the best NMRScore (CSP RMSD=0.5 ppm) but have a different structure from the native one (structural RMSD=6 angstroms). They are even better than some of the NMR ensemble structures in terms of NMRScore (see FIG. 5B). This is because the pyridine and isopentyl parts of these structures swap their positions but the pyrrolidine moiety remains at the central binding site (see FIGS. 1, 2 and 7). This orientation inside the binding site gives very large chemical shift perturbations for the protons in the five-member ring due to the ring-current effect, which is the major source of CSP for the GPI molecule upon binding with FKBP. Several other structures generated by the Dock program share similar features (see the cluster highlighted by an oval in FIG. 5B) and it suggests that Dock has found an alternate solution to the structure of this complex. The pyridine ring in these poses could give large CSP for protons on Phe36 and Ile90, while that in the native structure would likely not. Therefore, inclusion of CSP from the side chains of the FKBP protein in the NMRScore contributes to distinguishing poses from the native structure. Overall, the performance of NMRScore (ρ=0.64) is much better than that of Dock Score (ρ=−0.25).

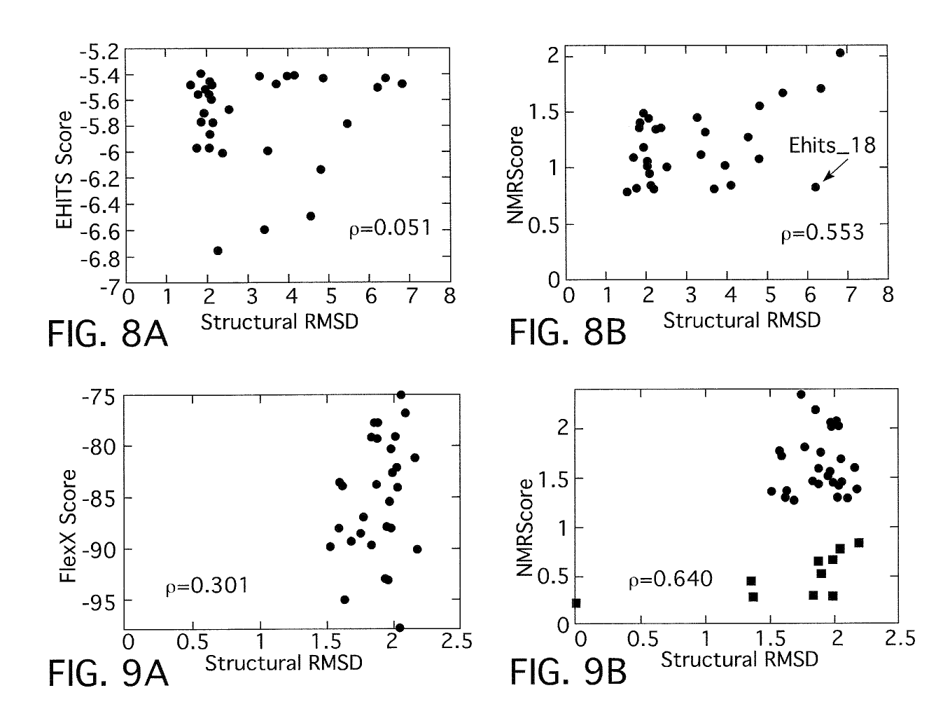

The top 30 ranked poses by eHiTs are spanned by a wide spectrum of structural RMSD from 1.6-7 angstroms (see FIG. 8). The highest ranked pose (RMSD 2.2 angstroms) is close to the native pose of the FKBP-GPI complex when compared to other docked poses. However, many lower ranked poses also have relatively small structural RMSD (see FIG. 8A). Therefore, it is difficult for eHiTs scoring function to rank these native-like structures. FIG. 8B plots NMRScore with respect to the structural RMSD for the top 30 poses. eHiTs_{—}21 has the lowest NMRScore at 0.78 ppm and the lowest structural RMSD at 1.6 angstroms. The poses with larger structural RMSD tend to have the worst (larger values) NMRScore. One prominent exception is eHiTs_{—}18 that has a relatively low NMRScore (0.82 ppm) with a very different structure from the native one (RMSD 6.2 angstroms). Similar to Dock_{—}3 and Dock_{—}6 mentioned above (see FIGS. 6 and 7), the isopentyl and pyridine moieties of eHiTs_{—}18 switch their positions relative to the native structure, resulting in a large structural RMSD, whereas the pyrrolidine ring of eHiTs_{—}18 is kept inside the hydrophobic pocket formed by the side chains of Tyr26, Phe46, Trp59 and Phe99. Therefore, eHiTs_{—}18 has a relatively low NMRScore compared to other poses, but its value is still far from the value of the native structure (see FIG. 8). Despite the presence of this alternative conformation, NMRScore (ρ=0.55) is much more correlated with structural RMSD than the eHiTs scoring function (ρ=0.05).

The poses generated by FlexX are clustered in a small RMSD range from 1.5 Å to 2.2 Å, which is close to the native structure (see FIG. 9). Their CSP RMSDs range from 1.3 ppm to 2.3 ppm. FlexX_{—}16 has the best NMRScore with a close-to-native structure (RMSD=1.6 Å). FlexX_{—}9 has the largest CSP RMSD of 2.3 ppm with a similar structure (RMSD=1.7 Å). Most of their deviations come from H51 and H52 in the pyrrolidine ring because these two protons in FlexX_{—}9 are in very close proximity to aromatic rings in FKBP, leading to unreasonably large chemical shift perturbations (−3.3 and −10.6 ppm, respectively). Actually all poses from FlexX suffer from this problem hinting that the non-bonded parameters are too forgiving with respect to close contacts. These results show that NMRS core is exquisitely sensitive to subtle differences of the ligand pose within the binding pocket, which allows us to detect unrealistic close contacts from a set of docking poses.

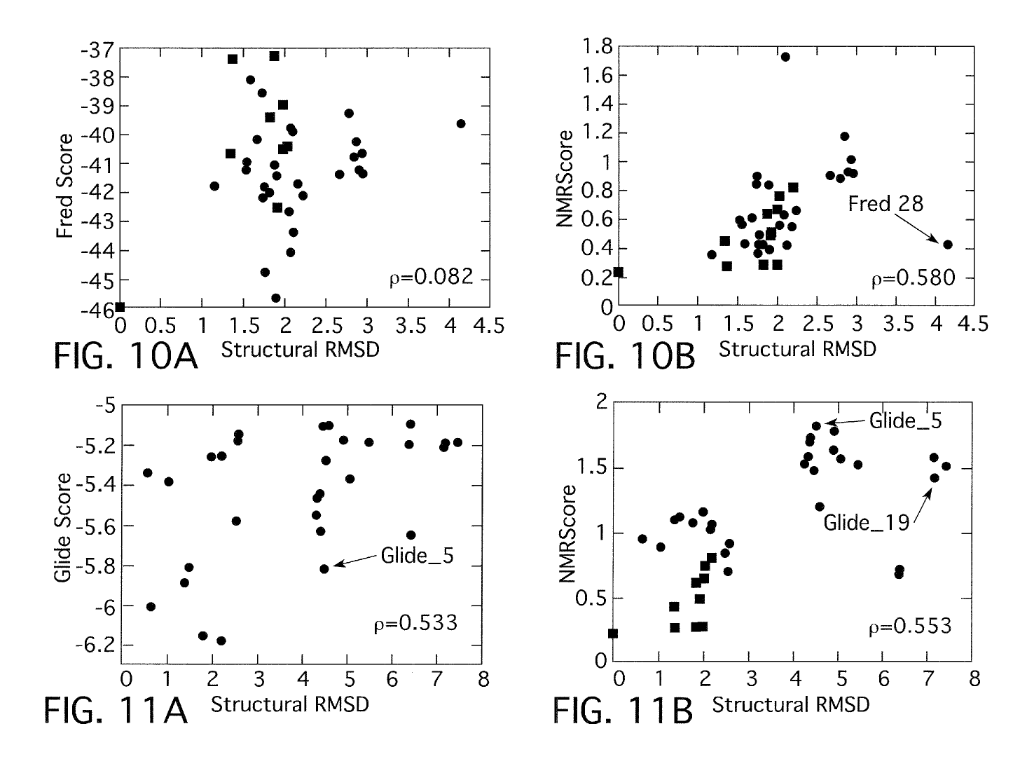

We selected the chemgauss2 scoring function implemented in the Fred docking program to score all Fred docking poses. In addition, we were able to score ten NMR structures using this scoring function (see FIG. 10A). The chemgauss2 scoring function ranks NMR_{—}6 as the best scoring structure, but mingles the rest of NMR structures with the docking poses. All top-ranked poses docked by Fred are clustered into the RMSD range from 1 Å to 3 Å except Fred_{—}26 (structural RMSD: 4.1 Å). As mentioned before for AutoDock_{—}19, Fred_{—}26 docks the pyridine ring into a shallow groove formed by Phe46, Phe48, and Glu54, while keeping other structural features close to the NMR structure. Consequently, the CSP RMSD of Fred_{—}26 is quite low (0.42 ppm). Many other docked poses with low structural RMSD also have better NMRScores, some even better than several of the NMR structures (see FIG. 10B). NMRScore also top-ranks the pose with the lowest structural RMSD. We conclude that while Fred is able to generate many correct native-like structures, its chemgauss2 scoring function ranks them inconsistently with structural RMSD (ρ=0.08). However, NMRScore gives an improved ranking according to structural RMSD (ρ=0.58). Overall, FRED generated many relevant poses, but its score function produced more of a scatter, which is partially alleviated by applying NMRScore.

The structures docked by Glide cover a structural RMSD range from 0.6 Å to 7.4 Å, which were clustered into four groups (see FIG. 11). The first group includes the poses with RMSD values from 0.6 Å to 2 Å, which have native-like structures. They are generally highly ranked according to the Glide scoring function (more negative) and NMRScore (lower CSP RMSD). The poses in the second group dock the isopentyl group deep into the major binding pocket, which gives a relatively large RMSD around 4-5 Å. Some of these structures are ranked high by Glide Score (see FIG. 11A), but usually have a poor NMRScores (see FIG. 11B). For example, Glide_{—}5 belongs to this group and has an NMRScore of 1.9 ppm. The structures in the third group are just like Dock_{—}3, Dock_{—}6 and EHITS_{—}18 described above: the isopentyl and pyridine parts switch their positions while the pyrrolidine ring is locked into the central binding site (RMSD ˜6-7). Therefore, these structures have a good NMRScore even though their RMSD from the native pose is quite large. There are three poses, Glide_{—}18, Glide_{—}19, and Glide_{—}22, in the last group, which have a structural RMSD over 7 Å because the pyridine ring of these structures lies in the major binding pocket. All of these structures are ranked poorly based upon both Glide Score and NMRScore.

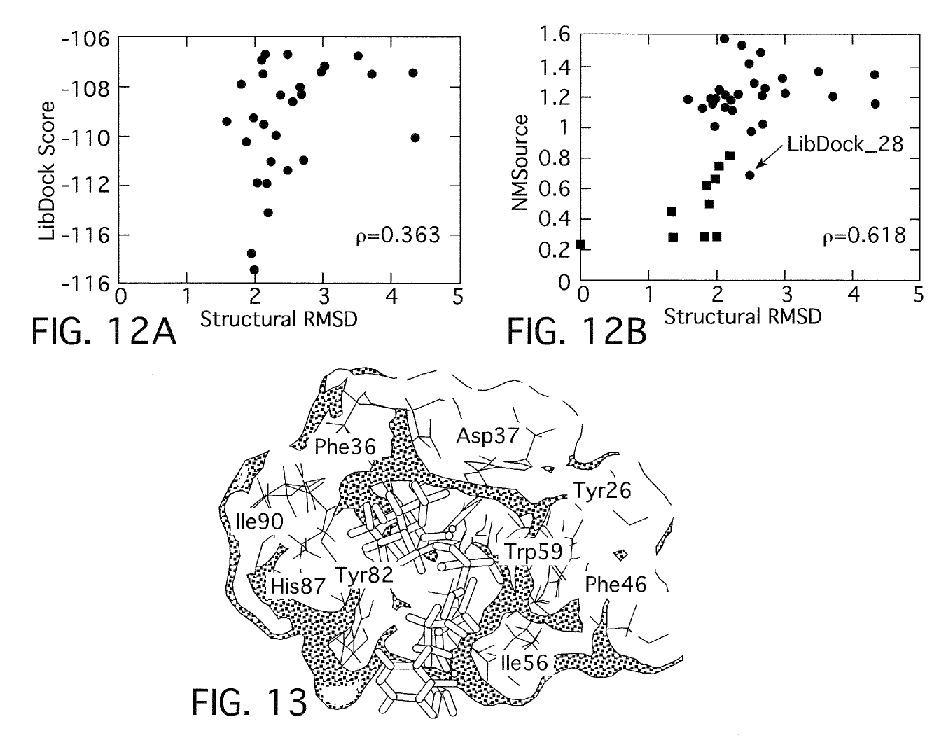

The structural RMSDs for LibDock poses range from 1.6 Å to 4.4 Å. LibDock_{—}1 has an NMRScore of 1.19 ppm with 2 Å RMSD from the native structure. However, there are many poses with similar structures that were poorly ranked (more positive) according to the LibDock scoring function (see FIG. 12A). Therefore, the LibDock scoring function cannot tell which native-like pose is the most favorable (ρ=0.36). Interestingly, LibDock_{—}28 (see FIG. 13) has the best NMRScore (CSP RMSD=0.68 ppm) with 2.5 Å RMSD from the native structure (see FIG. 12B). The isopentyl part of this pose is quite different from the native structure, but the pyrrolidine ring retains its position. Therefore, most of its CSP RMSD originates from the positioning of the isopentyl protons. LibDock_{—}29 shares the same feature. The Spearman correlation coefficient for NMRScore is 0.62, which indicates it significantly correlated with structural RMSD.

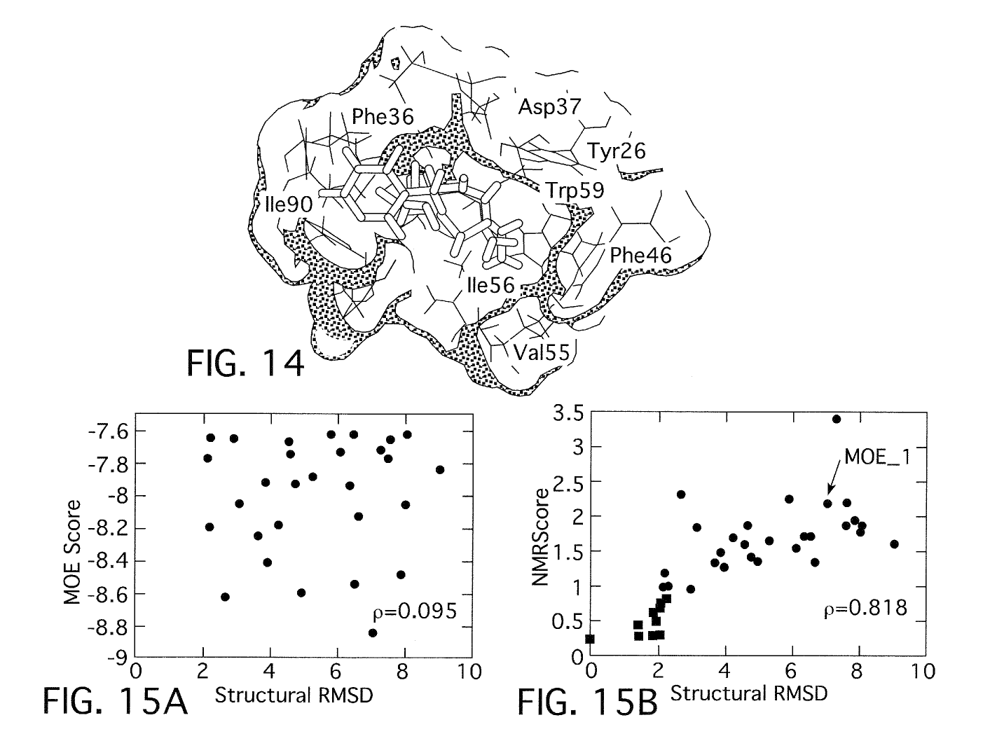

The top 30 ranked poses span a structural RMSD from 2 Å to 9 Å. The isopentyl moiety in the highest ranked pose (MOE_{—}1) docks deep into the central hydrophobic binding pocket (see FIG. 14), resulting in a very large structural RMSD (7.0 Å) with one of the worst NMRScores (CSP RMSD=2.2 ppm). As shown in FIG. 15A, the MOE scoring function cannot differentiate the close-to-native structures from the far-from-native structures (ρ=0.1). However, based on NMRScore, the closer to the native structure the docking pose (the smaller structural RMSD), the lower CSP RMSD (see FIG. 15B). Therefore, NMRScore is better than MOE in scoring and identifying native-like docking poses (ρ=0.82).

We have therefore experimentally confirmed the present invention, by comparing NMRScore with several “traditional” scoring functions associated with popular docking programs using the FKBP-GPI complex as the model system. Generally, these docking programs were able to find the correct binding site, but overall they were unable to differentiate native-like poses from non-native for the system tested. By incorporating the measured NMR experimental data according to the invention (such as CSP), NMRScore can clearly differentiate native from non-native poses. FlexX generates native-like structures but puts the ligand very close to the protein, as detected by NMRScore. Fred has the best docking structures, which have the lowest CSP RMSD and structural RMSD from the NMR structure. NMRScore, in conjunction with a docking program, is therefore useful to determine the ligand orientation inside a protein binding pocket. For some poses (Dock_{—}3, Dock_{—}6, eHiTs_{—}18) reported herein, the isopentyl group and pyridine ring did switch their positions, but overall the results with NMRScore are better than the scores from known docking programs, which means that NMRScore is better than other energy-based scoring functions in terms of scoring native-like protein-ligand complexes.

It should be noted that it is possible to assess the NMR chemical shift perturbations of protein pockets both pre- and post-binding, even though this study assessed the NMR chemical shift perturbations of only the small molecule (ligand). Also, in the context of the above reported data, which highlight the aberrations and not the overall better results of NMRScore overall, it should be borne in mind that the limitation of the method would be in the NMR chemical shifts were identical for the free and bound ligand, which would then give NMR results that cannot be helpful. Advantageously, the likelihood of this happening is extremely low, because when a small molecule in fact binds to its receptor, the local environment is inevitably perturbed and therefore registers an NMR CSP reading. The kinds of situations in which a zero CSP would occur at the same time binding did in fact occur would not be the situations that typically occur in living systems, namely, highly hindered or masked activity that would register zero CSP activity when in fact binding had taken place. In other words, at this writing the general nature of small molecule candidates for drug discovery, and the proteins for which their binding are the subject of investigation, are unlikely to demonstrate physico-chemical behavior that yields no NMR chemical shift perturbation.

Summarized very concretely, the goal of this invention is to use experimental nuclear magnetic resonance (NMR) information derived from an NMR apparatus combined with quantum mechanical NMR calculations on protein-ligand poses generated by docking methods to predict, using a computer, the binding orientation of a ligand (potential drug molecule) in a protein active site. This process first involves determining (by experimental means) the NMR chemical shifts of the protons of the ligand (and the protein, if so desired) both free and in complex with the protein. The difference between the solution chemical shifts and the bound chemical shifts is called the chemical shift perturbation (CSP). The next step (which can be done concomitant or after the experimental NMR studies) is to generate possible poses or orientations of the ligand bound into the protein active site using a molecular docking code via computer. Tens or hundreds of possible poses can be generated depending on how the investigator wants to proceed given the flexibility of the active site and the ligand. These structures are then energy minimized using the semiempirical Austin Model 1 (AM1) Hamiltonian and then modified neglect of differential overlap (MNDO) NMR calculations are carried out on these poses to generate protein bound chemical shifts for the ligand. Combined with the computed chemical shifts of the ligand free in solution, the computed CSPs can be generated. Using the experimental and computed chemical shifts the root-mean-squared difference (RMSD) is computed using a computer with a readout device such as a computer screen and/or printer. The lower the RMSD the better agreement between the computed chemical shifts and the experimental ones. By inference, the lower the RMSD the better the dock pose matches experiment and, hence, the more likely a given pose is the “true” experimental protein-ligand complex. The resulting “experimental” pose (or family of poses) solves the structure of the protein-ligand complex and can then be used to advance drug design and discovery efforts.

In theory, without any intention of being bound thereby, the present invention imparts unique accuracy to the scoring of docking poses in that it has harnessed an experimental NMR approach that is currently peripheral in the NMR disciplines today. The present invention uses direct NMR experimental data which, many believe, is difficult to use compared to other methods currently in favor. For example, the nuclear Overhauser effects (NOE) widely used at this writing was developed in large part because experimentalists believed that NMR CSP direct data was simply a “difficult quantity” to work with. NOE can be considered in this context to be a “binning” method, in that exact angstrom measurements are not sought but instead residence in a range, so that a particular NOE signal would identify the distance between two atoms as between 4-6 angstroms whereas a stronger signal would signify a different range. In order to think to use the present combination of features, therefore, the inventors had first to postulate and then confirm that if you use CSP to score docking poses you will importantly get better results than if you tried to score them with NOE, even though NMR experimentalists emphasize NOE for many reasons and one skilled in the art would (again, in theory) have been led to try NOE, not CSP, to score docking poses.

Given that the use of NMRScore as described herein to score docking poses for protein-ligand systems was confirmed to be a success, we also conclude that the same NMRScore as described herein can be used equally well for predicting protein structures, protein-protein contacts and protein-DNA or protein-RNA interactions. NMR Chemical Shift Perturbations are thus a powerful analytical tool to confirm which docking poses are useful for drug development initiatives.

1. A method of determining whether a docking software generated pose (or a pose generated by other means) is a good match with the experimental assessment of a paradigm protein target and paradigm ligand, and therefore that the pose will be useful and accurate for the same target and similar ligands, or similar targets and the same ligands, comprising:
obtaining NMR chemical shift perturbation data for either a paradigm protein target or a paradigm ligand, both before and after binding of the paradigm protein target and the paradigm ligand;
obtaining the NMRScore based on said chemical shift perturbation data according to Equation 1:
$$ρ = 1 - \frac{6 {\sum }_{i = 1}^{n} {d}_{i}^{2}}{n ( {n}^{2} - 1 )}$$
and assessing the RMSD generated by the NMRScore and evaluating whether the RMSD is below a certain threshold (generally 1 ppm), wherein an RMSD value of less than the threshold indicates a good match.

2. The method of claim 1, further comprising outputting the RMSD generated by NMRScore to a printer or computer display to a user.

3. The method of claim 1, further comprising obtaining NMR chemical shift perturbation data for each of a paradigm protein target and a paradigm ligand, both before and after binding of the paradigm protein target and the paradigm ligand, prior to obtaining an NMRScore for each of said paradigm protein target and said paradigm ligand, followed by calculating RMSD for each of said NMRScores.

4. The method of claim 1, wherein if NMR chemical shift perturbation data is identical for the ligand both before and after binding, then the data is ignored and a further step is performed wherein either a different paradigm protein target or a different paradigm ligand are selected for further evaluation.

5. The method of claim 1, wherein the paradigm ligand is a protein.

6. The method of claim 1, wherein the paradigm ligand is a peptide.

7. The method of claim 1, wherein the paradigm ligand is a DNA or PNA molecule.

8. The method of claim 1, wherein the paradigm ligand is an RNA molecule.

9. The method of claim 1, wherein the paradigm ligand is a small molecule drug candidate for drug discovery, wherein said small molecule candidate has a molecular weight of about 500 or less.

10. The method of claim 1, wherein when the RMSD equals zero, either a different paradigm protein target or a different paradigm ligand are selected for further evaluation.
